(19) United States
(12) Patent Application Publication
(10) Pub. No.: US 2009/0233261 A1
(43) Pub. Date: Sep. 17, 2009

(54) EDUCATIONAL TOOL

(76) Inventor: Joe Mindak, Hoboken, NJ (US)

Correspondence Address: MYERS WOLIN, LLC, 100 HEADQUARTERS PLAZA, North Tower, 6th Floor, MORRISTOWN, NJ, 07960-6834, US

(21) Appl. No.: 12/046,776

(22) Filed: Mar. 12, 2008

(51) Int. Cl. G09B 19/08

(52) U.S. Cl. 434/157

(57) ABSTRACT

An educational tool includes a plurality of removable stickers, at least one sticker further comprising at least one word in both a first language and a second language. The stickers may be arranged in sheets and/or a book and are intended to be removably applied to objects in an environment that are representative of the words provided on the stickers. Thus, a user can easily grasp the meaning of the word or phrase from the close proximity of the two versions of the word or phrase and the application of such word or phrase to an object that is representative of such word or phrase.

### FIELD OF THE INVENTION

The present invention is generally related to improvements in educational tools. More particularly, the present invention pertains to improvements in sticker sheets or books used for language education.

### BACKGROUND

Learning a different language is a challenging task. It is generally understood that the best way to learn a language is to become immersed in an environment that is dominated by such language, such as in a country having such language as its native tongue. Books, dictionaries, audio tapes, flash cards and the like are helpful for conveying information and for associating words of different languages. However, such learning tools tend to be separated from the environment of the new language in that there is usually no physical association between the learning tool, the word being learned, and the object represented by such word. For example, if someone is learning about different items in a kitchen, it would be useful to be physically present in a kitchen while practicing for purposes of making a visual and physical connection between the word and the object represented by the word, instead of, for example, learning the word by listening to an audio tape on the way into work.

### SUMMARY

An educational tool comprising a plurality of removable stickers, at least one sticker further comprising at least one word in both a first language and a second language. The stickers may be arranged in sheets and/or a book and are intended to be removably applied to objects in an environment that are representative of the words provided on the stickers. Thus, a user can easily grasp the meaning of the word or phrase from the close proximity of the two versions of the word or phrase and the application of such word or phrase to an object that is representative of such word or phrase. In addition, the sticker material enables a user to remove the sticker from the target object after the sticker word has been mastered or if it is otherwise desired not to use such stickers for whatever reasons.

### BRIEF DESCRIPTION OF THE DRAWINGS

FIG. 1 is a general representation of one embodiment of a book of the invention.

FIG. 2 is one embodiment of a page from a book of the invention.

FIG. 3 is one embodiment of an environment with stickers applied to a variety of items in the environment.

FIG. 4 illustrates various embodiments of sticker variations in accordance with the teaching of the invention.

FIG. 5 illustrates various embodiments of sticker variations in accordance with the teaching of the invention.

FIG. 6 illustrates various embodiments of sticker variations in accordance with the teaching of the invention.

FIG. 7 illustrates one embodiment of a page from a book in accordance with the invention.

FIG. 8 illustrates various embodiments of sticker variations in accordance with the teaching of the invention.

FIG. 9 illustrates one embodiment of a page from a book in accordance with the invention.

FIG. 10 is a flowchart showing one embodiment of a general learning process as taught by the instant invention.

FIG. 11 illustrates one embodiment of a page from a book in accordance with the invention.

FIG. 12 illustrates one embodiment of a variety of sticker shapes and arrangements in accordance with the instant invention.

### DETAILED DESCRIPTION OF THE PREFERRED EMBODIMENTS

The present invention relates generally to educational sticker books, and more particularly to educating people to learn new languages through the use of stickers. In one embodiment, the stickers are arranged so that words and phrases of the language to be learned are adjacent or nearly adjacent to the corresponding words or phrases of the native tongue of the user. In addition, such stickers are intended to be applied to the actual object represented by such word to further reinforce the connection between the word in the native tongue, the word in the foreign tongue and the object represented by such word.

Additionally, the invention is not limited to solely the English language being the native tongue. Rather, the invention contemplates using any base or native tongue against any other language that is to be learned by the user. For example, in the event a Japanese user wants to learn Italian then the Japanese phrase would be located along with the corresponding Italian word or phrase thus permitting the Japanese user to learn Italian. Thus, it is contemplated that all languages are useable as desired. Furthermore, while the discussion herein uses nouns to indicate or illustrate various items in a primary or native language for purposes of learning of a new language by having the corresponding nouns in a target foreign language, the present the invention is not limited to the use of nouns, but can use verbs, phrases, etc.

This disclosure describes the best mode or modes of practicing the invention as presently contemplated. This description is not intended to be understood in a limiting sense, but provides an example of the invention presented solely for illustrative purposes by reference to the accompanying drawings to advise one of ordinary skill in the art of the advantages and construction of the invention. In the various views of the drawings, like reference characters designate like or similar parts.

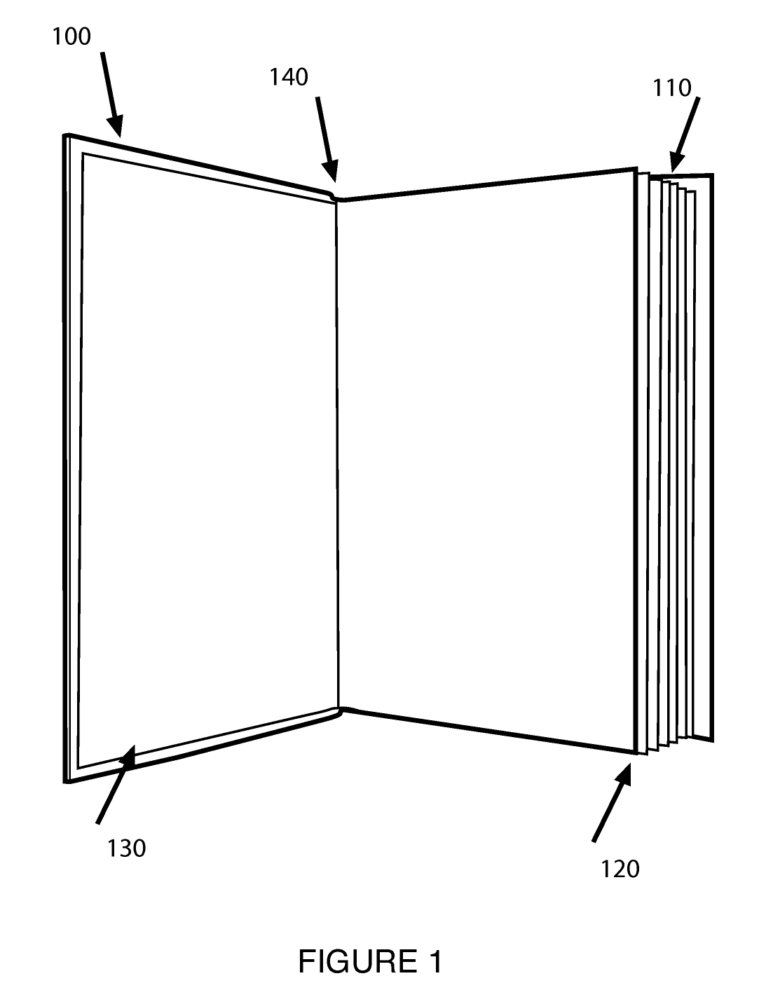

FIG. 1 illustrates one embodiment of a book that comprises stickers used in accordance with the teaching of the present invention, the book further comprising a front cover 100, a back cover 110, one or more pages 120, an end sheet 130 and a spine or base 140. Depending upon the type of binding some of these items may be omitted and other elements may be added to the book. The book preferably contains many types of pages that are to be described below including blank stickers that are included for people to write new words as they see fit.

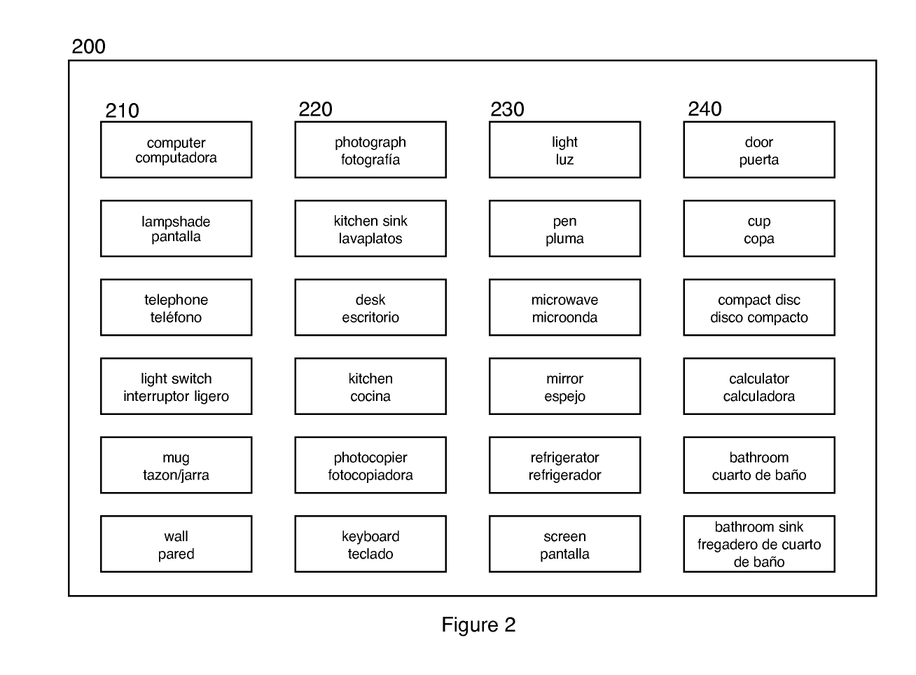

FIG. 2 illustrates one embodiment of a page 200 from the book of FIG. 1 showing a plurality of stickers in accordance with the instant invention. The stickers are arranged in regular one or more horizontal rows and one or more vertical columns across and down the page 200. Though most broadly any arrangement of stickers on the page would do, such as diagonally or some other arrangement that would enhance the learning experience. FIG. 2 illustrates an example of stickers utilizing English as a native or primary language and Spanish as a target or secondary language to be learned, with the native language being first, followed by the target or secondary language. Of course, other languages and other arrangements are contemplated. For example, the first row has stickers 210, 220, 230 and 240 containing English words and their Spanish variant as two word combinations per sticker. Sticker 210 represents the word computer/computadora, sticker 220 photograph/fotografia, sticker 230 light/luz and sticker 240 door/puerta in both English and Spanish to facilitate the learning of the language. These stickers are preferably removable from the page 200 so that a user may stick them to different items represented by the words illustrated on the stickers.

FIG. 2 illustrates a single page 200 generally shown as part of a book that is generally shown, for example, in FIG. 1. However, it will be understood that the education tool of the present invention can be represented in a variety of different ways. For example, single page 200 could be vended apart from a book construction as a stand alone sheet of stickers, where a user would purchase a sheet or sheets at a time instead of an entire book of stickers. Such sheet might be arranged by environment (i.e., the kitchen, bathroom, garage, workplace, etc.), by situation (i.e., walking through a popular tourist destination such as a zoo), by subject matter (i.e., numbers, shapes, animals, etc.) or the like. In addition, such single sheets may be provided with connections that allow the single sheets to be formed into a book. A variety of arrangements and constructions are contemplated.

The stickers are preferably made of a clear substrate that allows the stickers to not be an eyesore when applied to objects. The sticky material that facilitates the sticking action of the objects preferably lasts for a long period of time; from approximately six months for an exterior application up to one year for an interior application at which time than can be removed without damage to object. They can also be replaced and used again as they will still stick.

The stickers are intended to be temporarily and removably applied to objects until the user has mastered the secondary language for such objects, at which point the stickers could be removed from such objects. There are many types of sticky materials available in the marketplace for use with the stickers of the present invention. One such material is manufactured by Transilwrap Company, Inc. and is known as Trans-Cling II Low Tack Vinyl. This vinyl film is a low-tack pressure sensitive adhesive for use on smooth surfaces. It is available in white matte and a clear gloss surface and has the following characteristics: it can be applied to most clean, non-porous surfaces and withstands many weather conditions in temperatures ranging from −40° F. to 180° F. Typical applications for this Low Tack Vinyl are: interior and exterior doorway signs, refrigerator/freezer point of purchase signs, point of purchase decals for appliances, window decals for stores and cars and many more applications.

As previously indicated the Vinyl comes in both clear polished and white matte finishes. Either of the two finishes is testable for UV discoloration under extreme conditions. Including the adhesive, its thickness is from about 4.8 to 5.2 mil; it also has a thickness tolerance of 5% or 0.001 whichever is greatest. Additionally, the vinyl comes with good dimensional stability and a minimum application temperature of +50° F. It adheres to glass with a strength from 6 to 16 oz./in, and permits the material to adhere to an exterior surface for up to six months and for up to a year for interior surfaces. It has a fair resistance to water and humidity but a slight haze may develop in high humidity conditions that clears when normal humidity returns; it should be noted that immersion in water is not recommended for this product. Finally, Low Tack Vinyl has a shelf life of two years when stored at 74° F. and 50% relative humidity. It should be noted that whilst the Trans-Cling™ II Low Tack Vinyl has been indicated as one preferred material and adhesive for the stickers, the present invention contemplates using a generic adhesive and generic sticker material if desired.

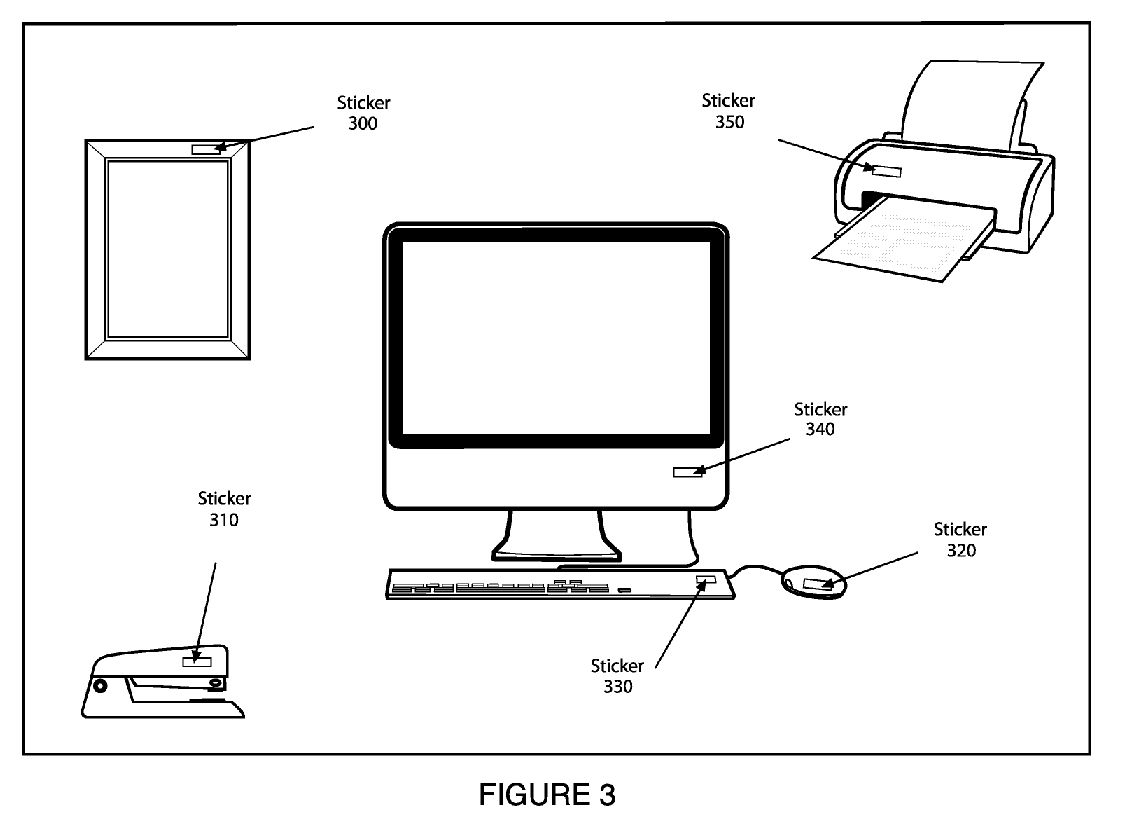

Returning to the figures, FIG. 3 is a desk 360 showing an environment for attaching stickers with stickers applied to a variety of items as taught by the instant invention. Items 300, 310, 320, 330, 340, and 350 represent stickers applied to a variety of typical desktop items. A user removes the one or more stickers from the sticker page 200 and upon reading the word in his or her native language attaches the one or more stickers to item identified by that word. For example, in the event that the user reads the word photo frame in the base language, the user removes the sticker from the page and attaches the sticker to frame 300. In the event that the user reads the word stapler in the base language, the user removes the sticker from the page and attaches the sticker to stapler 310. In the event that the user reads the word mouse in the base language, the user removes the sticker from the page and attaches the sticker to mouse 320. In the event that the user reads the word keyboard in the base language, the user removes the sticker from the page and attaches the sticker to keyboard 330. In the event that the user reads the phrase computer screen in the base language, the user removes the sticker from the page and attaches the sticker to computer screen 340. In the event that the user reads the word printer in the base language, the user removes the sticker from the page and attaches the sticker to printer 350. Thus, the user has attached the stickers including at least two languages (but alternatively more than two languages to facilitate more learning) to the several items; and since the stickers have a long adhesion time, the user has plenty of time to associate those particular foreign language words with the particular items. Thus, the stickers enable an easy and fast visual learning process that is simple for users of almost any age level to grasp.

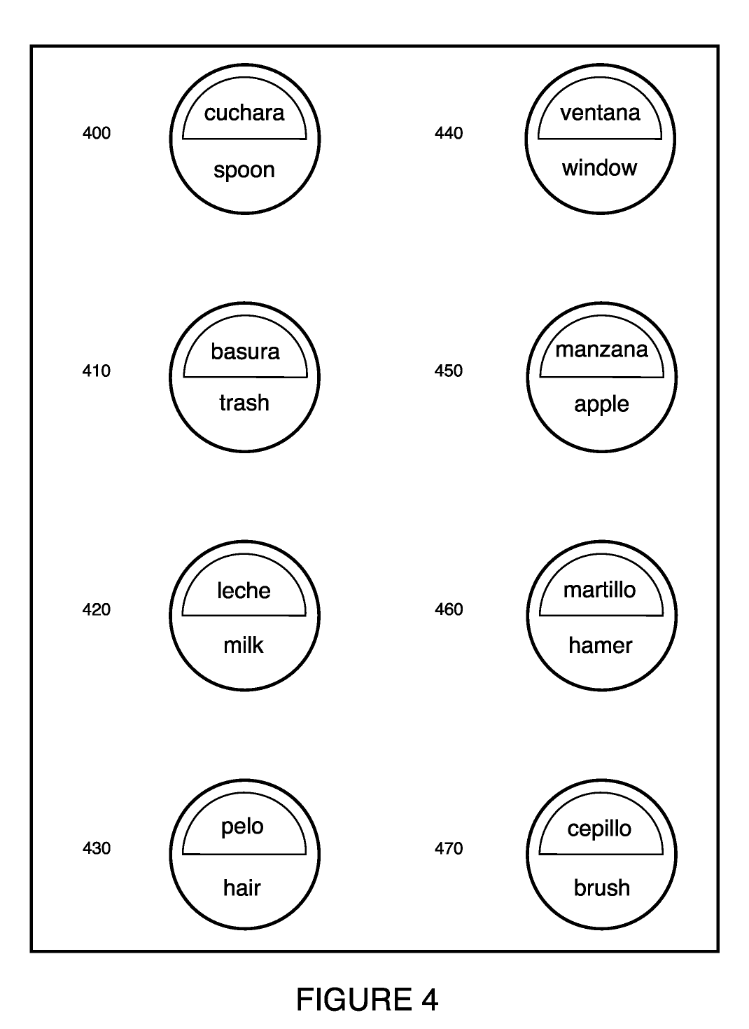

FIG. 4 illustrates a sticker variation where each language is represented with a different color background and or letters of the particular item having different colors. Other options are some areas of the sticker being transparent or partially transparent with a slight coloration. The identical or different background coloration or lack thereof is not dependent upon the word or phrase being in the primary or base language. Rather, the native or the language to be learned may have background coloration or both may have identical or clashing background colorations. Additionally, the words or phrases themselves are colored in identical or different colors. Thus, items 400, 410, 420, 430, 440, 450, 460 and 470 represent various sticker color combinations. Each of these represents Spanish/English combinations of words such as cuchara/spoon (400), basura/trash (410), leche/milk (420), pelo/hair (430) ventana/window (440), manzana/apple (450), martillo/hammer (460), and cepillo/brush (470). Items 430 and 470 demonstrate a reverse of the partial or total coloration from what is shown in items 400-420 and 440-460.

Circular stickers 400-470 represent the primary language English in the bottom area and the Spanish language that is to be learned in the upper area of the circular sticker. It should be noted that a variety of modifications are contemplated. Namely, the target and primary language can change locations on the stickers or even be arranged horizontally across from one another or in any manner desired on the sticker. Additionally, the stickers may be transparent, partially transparent but colored or fully opaque and colored. Other configurations, coloring, shading, etc. are contemplated. Further, the transparency, partial transparency with coloration or opaque coloration may be identical or different for both primary and target language areas. Further, in the embodiment shown in FIG. 4, the transparency, partial coloration or opaque coloration is extended solely in the word or phrase area of the sticker whether target or primary but is also extensible to the borders of the base sticker material on the page of the book where the sticker is originally affixed. Of course, the sticker and backing on the sticker page may be any shape that is machinable from circles, squares, triangles, rectangles, half moons and any other regular shape, octagons, pentagons, trapezoids, hexagons, heptagons, octagons, etc.; additionally, the stickers may represent the items themselves as shown in another figure and various irregular shapes such as shown later in another figure.

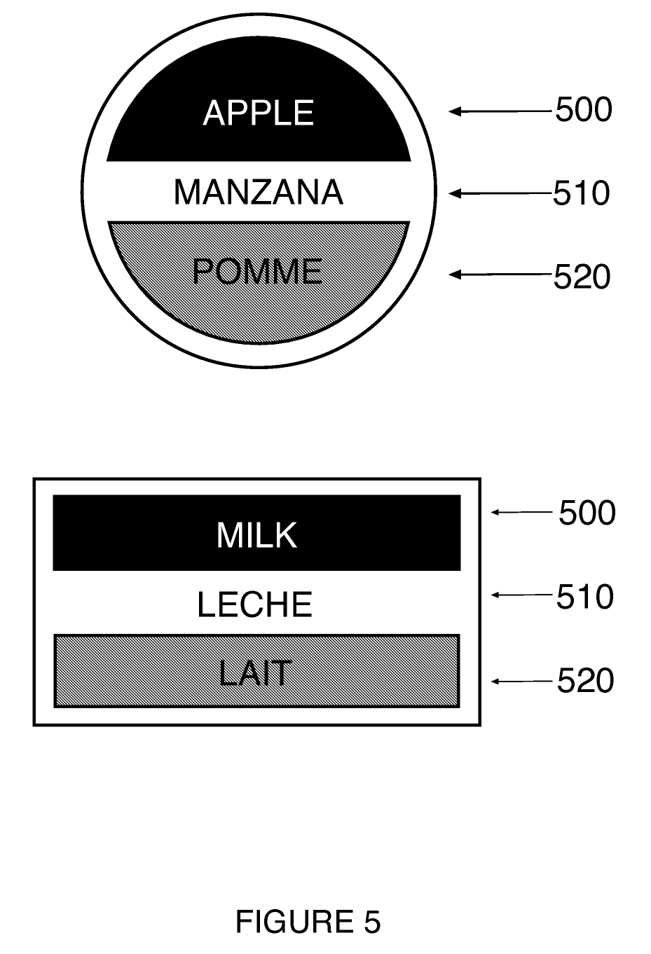

FIG. 5 illustrates one embodiment of a sticker variation where three languages are on one sticker such that the background for the three languages is of a different color and or letters of the particular item having different colors. FIG. 5 represents a circular sticker 560 and a rectangular sticker 570. Each of these illustrates the general concept of having more than two languages per sticker representing a single item. For example, sticker 560 has items 500, 510 and 530 representing an apple 500, a manzana 510 and a pomme 520 whilst sticker 570 has items 530, 54, 550 representing milk 530, leche 540 and lait 550 so that three languages can be learned by a user readily easily. Of course, it is preferred that any given sticker is to have at least two but possibly more than two words or phrases in different languages representing a single item.

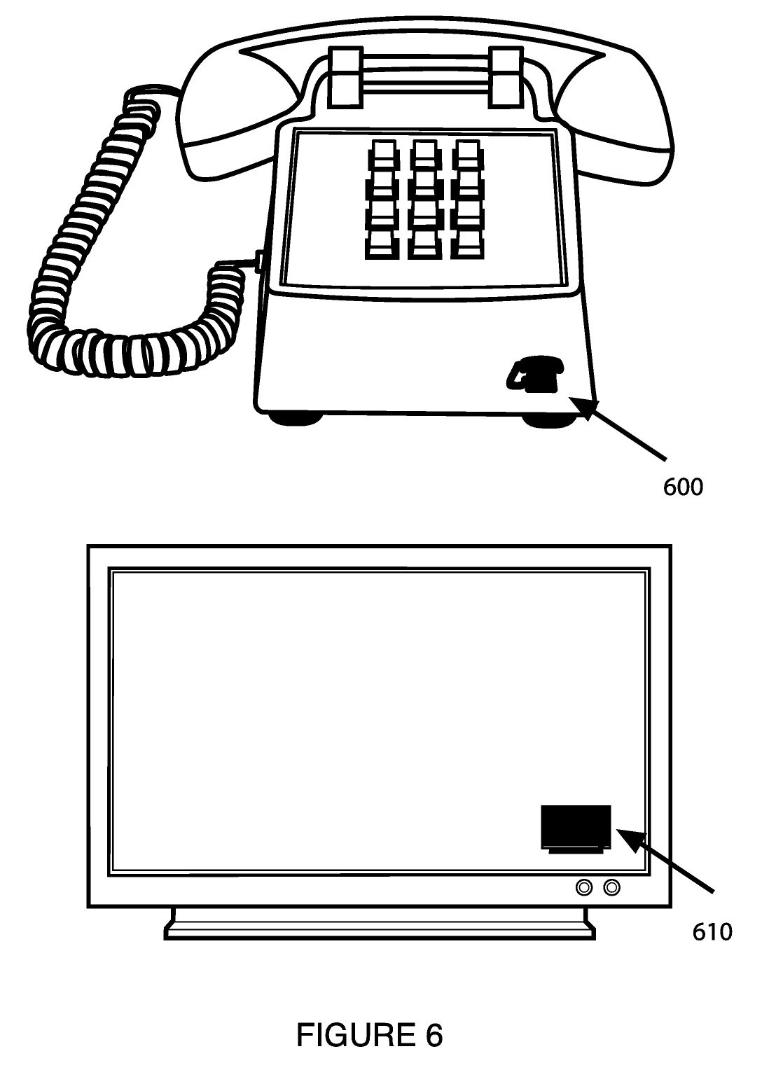

FIG. 6 illustrates one embodiment of a sticker variation such that the shape of the sticker represents the particular word and matching item. Sticker 600 represents the phone to which a user has attached it and corresponding word or phrase in two or more languages are printed on the sticker 600 thus facilitating the learning of the new one or more languages by visual association with the item. Similarly, sticker 610 represents the video terminal to which a user has attached it and corresponding word or phrase in two or more languages are printed on the sticker 600 thus facilitating the learning of the new one or more languages by visual association with the item. As before, the stickers have printed on them word(s) and/or phrase(s) in the two or more languages or both in the event of translation problems.

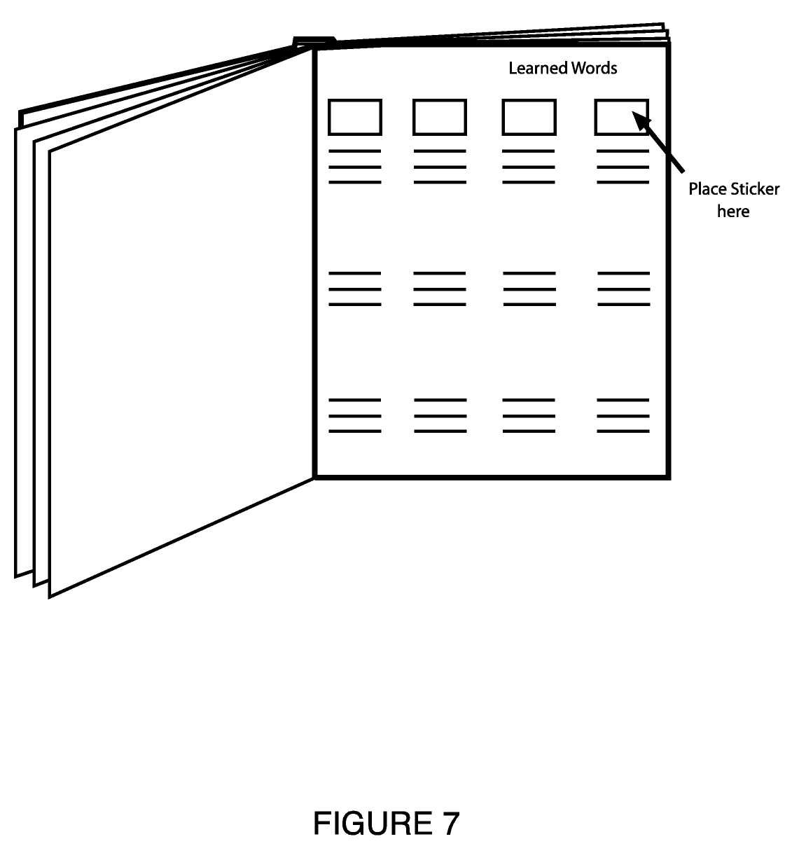

FIG. 7 illustrates a page from a book of one embodiment of the present invention entitled “Learned Words” that starts as a blank page on which are placed stickers representing words that have been mastered by the user. The page is shown organized in a regular area of rows and columns with an area indicating that the “Learned Words” should be affixed to this area. This page(-s) is preferably located somewhere in the sticker book and is used by the owner of the book to stick the ‘Learned Words’ that he or she has mastered onto locations prepared for that purpose. Optionally, there are some lines so that the user can make a sentence or phrase using the word in the target or secondary language so as to further facilitate the learning experience. The “Learned Words” page also serves as a useful listing of words in the nature of a vocabulary list to provide a refresher environment for reviewing mastered words in series.

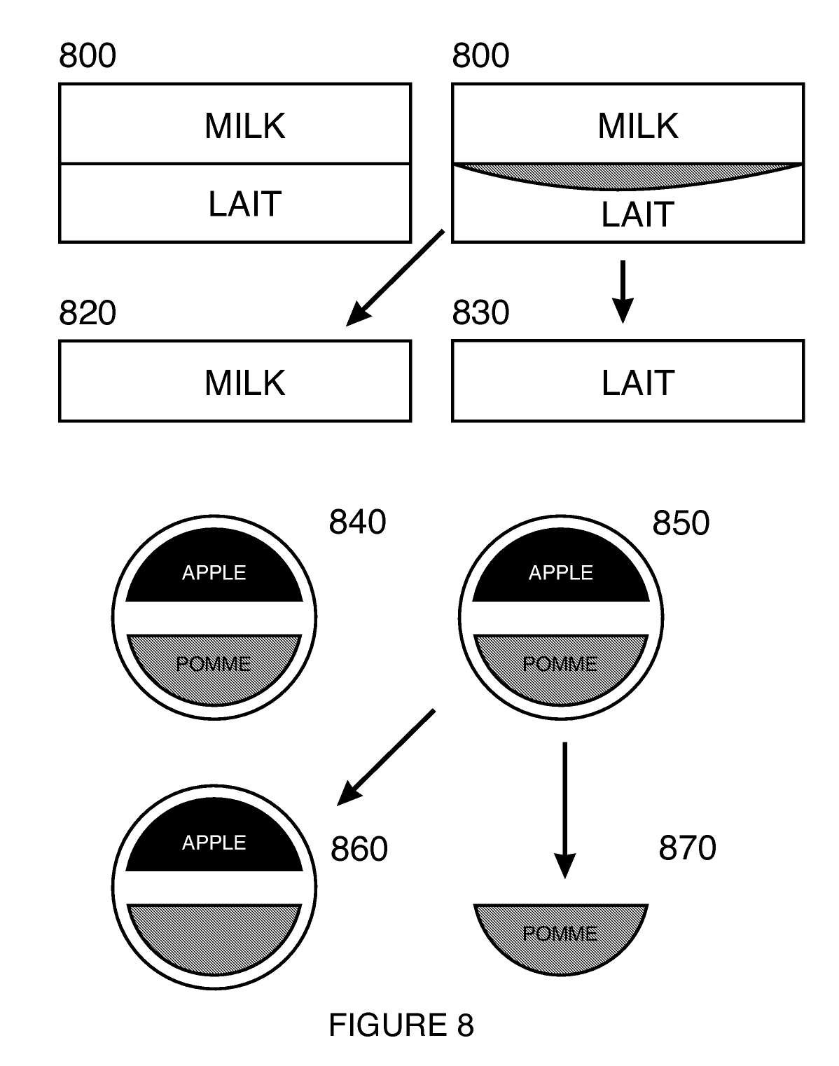

FIG. 8 illustrates a variation of the sticker usage as taught by this invention whereby the stickers are perforated so that you can separate the first native language from the second language and just apply the second “target” language to the object. Items 800-830 and 840-870 illustrate two examples of the removal of a target language perforated sticker from the page so that the user can affix that target language sticker to the item it indicates. In the first step 800 and 840 the primary language is English and the secondary language is French. In this example, sticker 800 has milk/lait and sticker 840 has apple/pomme as its noun and or phrase. In the next step 810/850, a user removes the bottom stickers representing lait and pomme from the backing and then the sticker 830 and 870 representing the lait and the pomme are separated from the backing 820 milk and 860 apple.

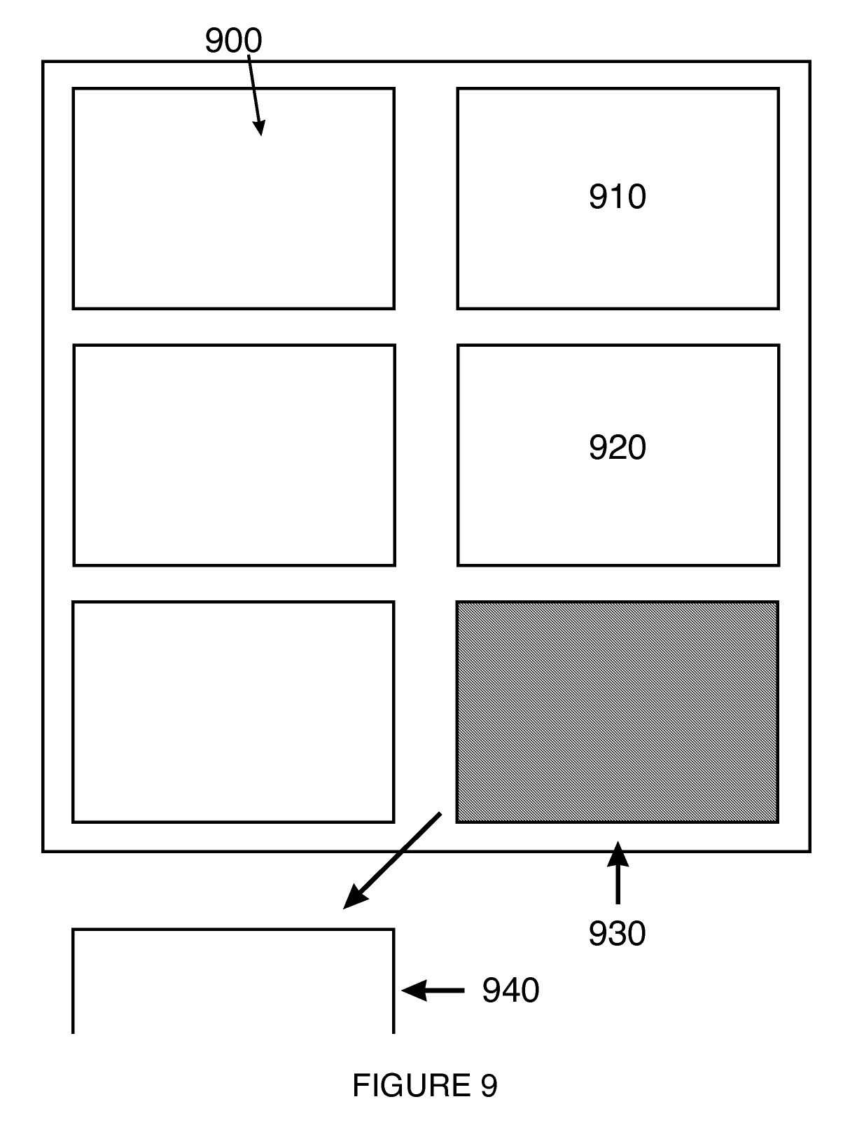

FIG. 9 illustrates one embodiment of a page from a book of laminated double-sided, re-usable flash cards that are perforated and separable like laser-printed business cards on which can be applied to each side the perforated stickers. Additionally, the flash cards have a picture of the item represented by the word and or phrase in a native language. These flash cards are removable from the backing material 900. Item 910 represents a flash card as it is before being separated from the backing material that is made of generic material. Item 920 represents the flash card as it is being removed from the backing material itself. Finally, the flash card 940 has been removed from the backing material. The backing material may be a regular generic backing material or the flash card maybe perforated all the way through the backing material such that item 930 represents open space in the page backing material 900. As with the “Learned Words” page, the flash cards provide an additional tool for learning another language in a more interactive, self-testing manner.

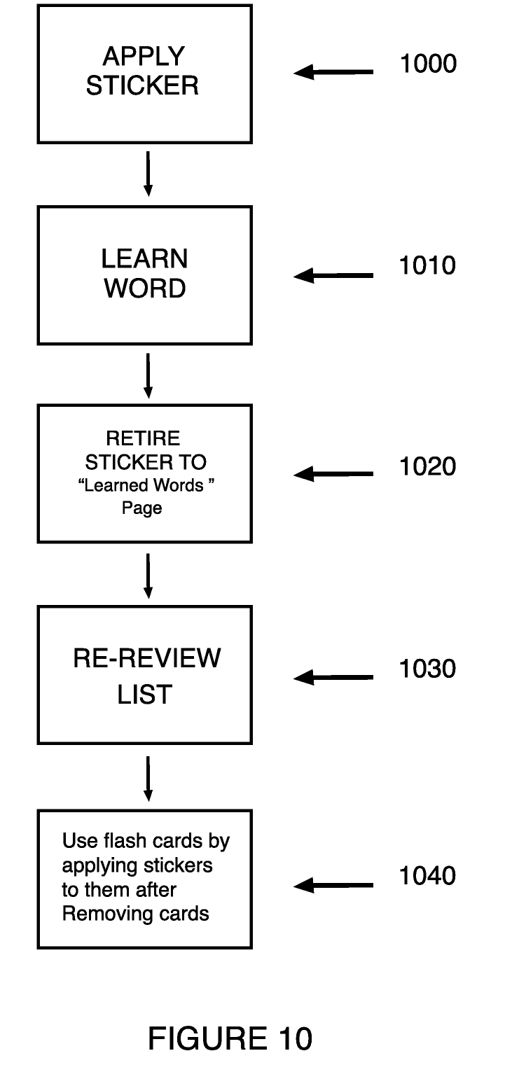

FIG. 10 is one embodiment of a flowchart showing the general learning process as taught by the instant invention. The process starts at 1000 with a user removing and applying one or more stickers to objects. As this process continues, the user begins to learn 1010 and remember one or more words, and eventually the user will remove the sticker from the object after mastering the language dedicated to such object. To further facilitate the learning of words, the user might retire learned words stickers 1020 to the “Learned Words” page (FIG. 7) so as to permit him or her to go on to other word and or phrases. Then, he or she re-reviews 1030 the “Learned Words” page so as to ensure that he or she has mastered those words over time. Finally, the user removes the flashcards from the backing material and uses them by applying stickers to them in a typical flash card fashion where a card is flashed before the user randomly by another person, or where if alone he or she shuffles the cards and learns them one by one solo.

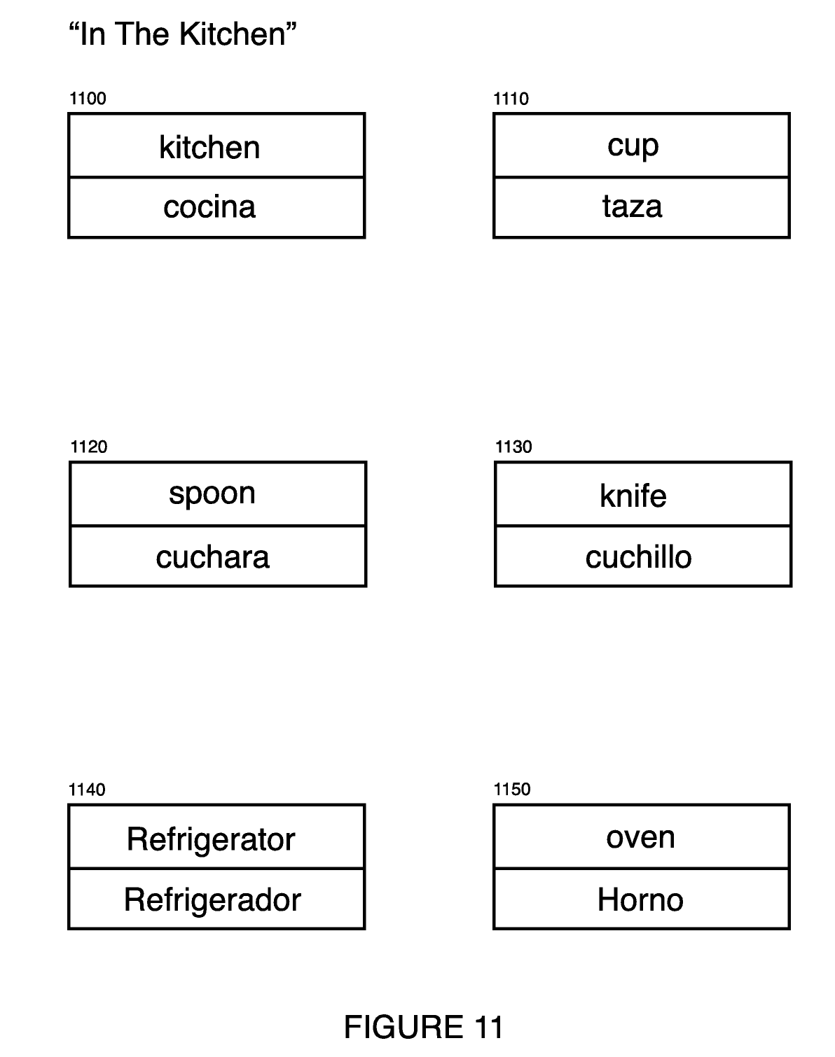

FIG. 11 is an environmental arrangement of stickers such as “In the Kitchen,” which is in contrast to the random grouping shown in FIG. 2 for example. There may be many types of arrangements of this sort. Thus, most broadly, the instant invention teaches a generic environment page where stickers specific to that environment are arranged so as to facilitate learning many things about a unique environment at one time. Some typical types of environments include but are not limited to: “In the Bathroom,” “In the School,” “In the Store,” “In the Restaurant,” “In the Mall,” “In the Automobile,” “In the Office,” “At the Beach,” “At the Zoo,” etc. As before, the stickers are arranged in one or more rows and one or more columns of sticker items 1100, 1110, 1120, 1130, 1140 and 1 150. The stickers are entirely removable from the backing material as a whole or partially removable from the backing material; thus, both native and target language as one or separately removable or alternatively, only the target language to be learned is removable from the backing material. For example, the invention contemplates several different types of removing options; in sticker 1100, the kitchen and cocina stickers are removable together as one unit, as separate items each, or that the primary language is not removable and only the target language is removable from the backing material. This principle applies to the other sticker items 1110 cup/taza, 1120 spoon/cuchara, 1130 knife/cuchillo, 1140 refrigerator/refrigerador, 1150 over/horno. Other options are contemplated.

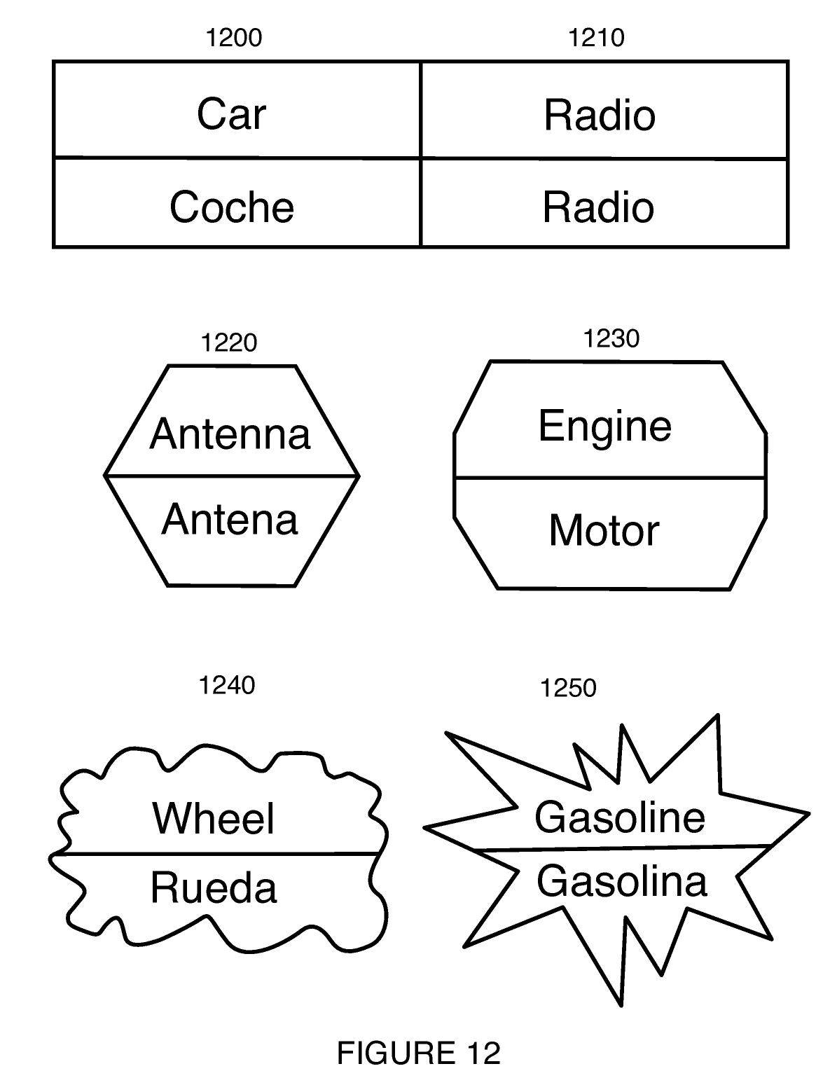

FIG. 12 is an illustration of one embodiment of a variety of sticker shapes and arrangements showing that the stickers may be placed close together. Sticker items 1200 car/coche and 1210 radio/radio are arranged directly adjacent to each other without any backing material. Additionally, any sticker or combination of stickers is extensible across the entire backing material page or down the page depending upon machining requirements.

Finally, it should be noted that stickers of any size and shape from the regular shapes like hexagon 1220 and octagon 1230 to the curved shape 1240 and the sharp spiked shape of 1250. Any combination of the foregoing is contemplated herein

While the present invention has been described at some length and with some particularity with respect to the several described embodiments, it is not intended that it should be limited to any such particulars or embodiments or any particular embodiment, but it is to be construed with references to the appended claims so as to provide the broadest possible interpretation of such claims in view of the prior art and, therefore, to effectively encompass the intended scope of the invention. Furthermore, the foregoing describes the invention in terms of embodiments foreseen by the inventor for which an enabling description was available, notwithstanding that insubstantial modifications of the invention, not presently foreseen, may nonetheless represent equivalents thereto.

What is claimed is:

1. An educational tool comprising a plurality of removable stickers, at least one sticker further comprising at least one word in both a first language and a second language.

2. The educational tool of claim 1, further comprising at least one blank sticker that is personalizable.

3. The educational tool of claim 1, further comprising a plurality of pages of stickers assembled to form a book of stickers.

4. The educational tool of claim 3, wherein the stickers on each page are randomly grouped.

5. The educational tool of claim 3, wherein the stickers on each page are grouped by environment.

6. The educational tool of claim 1, wherein each language is represented in a different color.

7. The educational tool of claim 1, wherein each language is represented in different shading.

8. The educational tool of claim 1, wherein the at least one sticker further comprises a shape that is representative of the at least one word.

9. The educational tool of claim 1, wherein a first portion of the at least one sticker comprising the at least one word in the first language is separable from a second portion of the at least one sticker comprising the at least one word in the second language.

10. The educational tool of claim 9, wherein the at least one sticker is perforated between the first and second languages.

11. The educational tool of claim 1, the at least one sticker further comprising the at least one word in a third language.

12. The educational tool of claim 11, wherein each language is represented in a different color.

13. The educational tool of claim 1 1, wherein a first portion of the at least one sticker comprising the at least one word in the first language is separable from a second portion of the at least one sticker comprising the at least one word in the second language, and is further separable from a third portion of the at least one sticker comprising the at least one word in the third language.

14. The educational tool of claim 1, wherein a plurality of stickers are arranged in immediate contact with one another.

15. The educational tool of claim 1, further comprising a plurality of pages assembled to form a book, at least one of the pages comprising a plurality of stickers, at least one of the pages comprising at least one intended location for placement of at least one sticker from said plurality of stickers.

16. The educational tool of claim 15, further comprising a lined area adjacent the intended location for practicing usage of the at least one word displayed on the at least one sticker.

17. The educational tool of claim 15, wherein the at least one page comprising the at least one intended location further comprises a plurality of removable flash cards.

18. The educational tool of claim 1, wherein the at least one sticker is adapted for non-adhesive, removable attachment to an object.

19. The educational tool of claim 1, wherein the at least one sticker further comprises a cling material for removable attachment to an object.

20. The educational tool of claim 1, wherein the at least one sticker further comprises a vinyl material for removable attachment to an object.

21. A method of utilizing an education tool comprising:
a) providing a plurality of removable stickers, at least one sticker further comprising at least one word in both a first language and a second language; and
b) applying the at least one sticker to an object represented by the at least one word for purposes of learning how to designate the object in more than one language.

22. The method of claim 21, comprising providing a book of stickers.

23. The method of claim 21, wherein each language is represented in a different color or shading.

24. The method of claim 21, wherein a first portion of the at least one sticker comprising the at least one word in the first language is separable from a second portion of the at least one sticker comprising the at least one word in the second language.

25. The method of claim 21, wherein the at least one sticker is adapted for non-adhesive, removable attachment to an object.

26. The method of claim 21, wherein the at least one sticker further comprises a cling material for removable attachment to an object.
